(19) United States
(12) Patent Application Publication
(10) Pub. No.: US 2022/0311626 A1
(43) Pub. Date: Sep. 29, 2022

(54) CLOUD-BASED IDENTITY PROVIDER INTERWORKING FOR NETWORK ACCESS AUTHENTICATION

(71) Applicant: Cisco Technology, Inc., San Jose, CA (US)

(72) Inventors: Srinath Gundavelli, San Jose, CA (US); Indermeet Gandhi, San Jose, CA (US)

(21) Appl. No.: 17/211,178

(22) Filed: Mar. 24, 2021

(51) Int. Cl. H04L 9/32; H04L 29/06

(52) U.S. Cl. CPC H04L 9/3271; H04L 63/0876; H04L 9/3213

(57) ABSTRACT

Techniques for utilizing an extensible authentication protocol (EAP) to interwork with a cloud-based identity provider supporting OAuth based authentication and authorization interfaces. An access network may be accessible by a user device interacting with a service provider network configured to securely transmit encrypted credentials from the user device, over EAP, and relay the encrypted credentials to a cloud-based authorization server, using a backchannel over hypertext transfer protocol secure (HTTPS) via OAuth, for authorization and authentication of the user device to access the access network. The network may be configured as a public wireless network, a private wireless network, a public cellular network, a private cellular network, and/or an OpenRoaming Network.

### TECHNICAL FIELD

The present disclosure relates generally to utilizing an extensible authentication protocol (EAP) to interwork with a cloud-based identity provider supporting OAuth based authentication and authorization interfaces.

### BACKGROUND

Today, extensible authentication protocol (EAP) is a widely used protocol for network access authentication in many types of access networks. Implementation of such a protocol can require an EAP authenticator, a user device configured as the EAP supplicant, and authentication, authorization, and accounting (AAA) server configured as the authorization server. For access authentication between the user device and an AAA server, different EAP-based authentication methods (e.g., EAP transport layer security (EAP-TLS), EAP tunneled transport layer security (EAP-TTLS), EAP subscriber identity module (EAP-SIM), and EAP authentication and key agreement (EAP-AKA)) and associated credentials are used. The use of AAA for access authentication of a user device belonging to the same operator domain, or from a roaming partner domain, is feasible as long as there is a AAA with the provisioned user credentials for performing the access authentication.

However, as the lower-end of the enterprise business segment rapidly transitions towards cloud-based services, leveraging the identity management of the cloud identity provider, the requirements around maintaining user credentials or the AAA server has proved to be a challenge for such entities. Additionally, many enterprises and network service providers are not interested in providing identity management services or managing authorization servers. Instead, these enterprises want to support access authentication based on cloud-based identity provider domains.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment for implementing at least some of the various technologies disclosed herein. The environment includes an access network accessible by interacting with a service provider network configured to securely transmit encrypted credentials from a user device to a cloud-based authorization server for authorization and authentication of the user device to access the access network.

FIGS. 2A and 2B collectively illustrate a data flow diagram of an example process according to which a user device may attempt to access an access network that utilizes a cloud-based authorization server for authentication and authorization of the user.

FIG. 3 illustrates a flow diagram of an example method for using an access point associated with a network to transmit encrypted credentials of a user device to a cloud-based authorization server for authorization and authentication of the user device.

FIG. 4 illustrates a flow diagram of an example method for a user device to request access to an access network by receiving input representing credentials associated with a cloud-based authorization server for authorization and authentication to the access network, encrypting the credentials, and sending the credentials to an access point associated with the access network.

FIG. 5 illustrates a computer architecture diagram showing an example computer hardware architecture for implementing a network device that can be utilized to implement aspects of the various technologies presented herein.

### DESCRIPTION OF EXAMPLE EMBODIMENTS

### Overview

This disclosure describes a method of utilizing an extensible authentication protocol (EAP) to interwork with a cloud-based identity provider supporting OAuth based authentication and authorization interfaces to authenticate and authorize a user device for access to an access network. The method includes receiving, at an access point associated with a network and from a user device, a first request for access to the network. The method may further include sending, to the user device and from the access point, a second request to provide identity credentials associated with an identity provider. The method may further include receiving, at the access point and from the user device, the identity credentials. The method may further include sending, from the access point and to the identity provider, the identity credentials. The method may further include receiving, at the access point and from the identity provider, a first challenge to authenticate an identity of a user of the user device. The method may further include sending, from the access point and to the user device, the first challenge. The method may further include receiving, at the access point and from the user device, first encrypted data including first credentials to authenticate the identity of the user. The method may further include sending, from the access point and to the identity provider, the first encrypted data. The method may further include determining, at the access point and based at least in part on sending the first encrypted data, whether the identity provider authenticated the identity of the user.

Additionally, or alternatively, the method includes sending, from a user device and to an access point associated with a network, a first request for access to the network. The method may further include receiving, at the user device and from the access point, a second request to provide identity credentials associated with an identity provider. The method may further include receiving, at the user device, first input indicating the identity credentials. The method may further include sending, from the user device and to the access point, the identity credentials. The method may further include receiving, at the user device and from the access point, a first challenge to authenticate an identity of a user of the user device. The method may further include receiving, at the user device, second input indicating first credentials to authenticate the identity of the user. The method may further include encrypting, by the user device, the first credentials to authenticate the identity of the user as first encrypted data. The method may further include sending, from the user device and to the access point, the first encrypted data. The method may further include receiving, at the user device and from the access point, an indication of whether the identity provider authenticated the identity of the user.

The techniques described in this disclosure may be performed as a method and/or by a system having non-transitory computer-readable media storing computer-executable instructions that, when executed by one or more processors, performs the techniques described above.

### EXAMPLE EMBODIMENTS

As discussed above, many enterprise businesses and network service providers are rapidly transitioning to cloud-based services and are not interested in providing identity management services or managing authorization servers. Instead, these enterprises want to support access authentication based on cloud-based identity provider domains (e.g., gmail.com, facebook.com, azure.net, etc.). While OAuth 2.0 provides a means for a delegation of access, where a service provider may be able to obtain access tokens from an authorization server that may be utilized to access certain resources without having explicit access to identity credentials of the owner of such resources, the protocol is tightly integrated into hypertext transfer protocol secure (HTTPS) based services using hypertext transfer protocol (HTTP) redirect for user authentication directly with a cloud-based identity provider. For example, a user may navigate to a website offering a service, the site redirects the user to an identity provider for login, and then following OAuth and OpenID Connect redirections, the user may access the service. However, this approach cannot be employed for basic access authentication at the access layer.

OAuth 2.0 relates to delegation of access, and the protocol allows a service provider network to be able to obtain access tokens from an authorization server, which may then be used to access resource(s) without having explicit access to the identity credentials of the owner of such resource(s). For example, an exchange of messages between an access point associated with a service provider network, an authorization server, and a user device may be a practical means to grant access tokens for a specific purpose. OAuth 2.0 framework is integrated into the HTTPS web service layer and there is extensive use of the same in the internet. Additionally, OpenID Connect, being an extension on top of OAuth 2.0, brings authentication support to OAuth, while OpenID Connect still relies on the delegation provided by OAuth. However, such a handshake results in an identity token that has the information of a user and/or additional properties associated with the user and/or user device.

This disclosure describes techniques for utilizing an extensible authentication protocol (EAP) to interwork with a cloud-based identity provider supporting OAuth based authentication and authorization interfaces to authenticate and authorize a user device for access to an access network, such as, for example, a Wi-Fi network, a mobile network operator (MNO) network (e.g., public 5^{th} generation (5G) mobile network, private 5G mobile network, and/or next-generation mobile networks), an OpenRoaming network, or any other type of access network. In some examples, the user device and a service provider network (also referred to as the MNO network) may utilize EAP for access authentication, while an OpenID Connect call flow may be activated on the backend, between the service provider network and a cloud-based identity provider, and tied with the EAP access authentication, such that an authentication exchange that happens in classic OAuth between the user and the authorization server may now be realized over EAP by moving encrypted objects between the user device and the cloud-based identity provider without exposing the user's credentials to the service provider network. As further discussed herein, this approach may provide the ability for a user device to use EAP to complete access authentication with a cloud-based identity provider that supports OAuth and/or OpenID Connect.

Take, for example, an environment in which a user may wish to connect a user device to an access network (or a service provider network), such as, for example, a public and/or private Wi-Fi network, a public and/or private MNO network (e.g., a 5^{th} generation (5G) mobile network), and/or an OpenRoaming network. In some examples, a user device may have a user agent, or other software, installed thereon, such as, for example, an EAP supplicant. Additionally, or alternatively, the user agent may be configured to communicate with an access point associated with the network. The user device may send a request for access to the network to an access point associated with the network and/or may otherwise attach to the network. The access point may be configured as any network node included in a network. For example, the access point may be configured as a 5^{th} generation (5G) session management function (SMF) and/or a similar node in a next-generation mobile network. Additionally, or alternatively, the access point may be configured as a wireless local area network controller. In response, the access network may return an EAP request/identity message to the user device. In some examples, the EAP request/identity message may include an indication of a cloud-based identity provider realm. For example, with a cloud-based identity provider, such as, for example, “google.com,” the message may include an indication of a corresponding realm, such as, for example, “@google.com”. In response to the EAP request/identity message, the user device may send an EAP response/identity message to the access point. In some examples, the EAP response/identity message may include a network access identifier (NAI) associated with the cloud-based identity provider (e.g., user@gmail.com).

Once the access point receives the EAP response/identity message, the service provider network may make a backchannel request, over HTTPS, for example, to an authorization server associated with the cloud-based identity provider requesting an identity token. In some examples, such a request may include an indication of the scope uniform resource identifiers (URIs) associated with the cloud-based identity provider and/or request for an additional access token. Additionally, or alternatively, the request may include an indication of the NAI associated with the cloud-based identity provider (e.g., user@gmail.com) received from the user device. In response to the backchannel request, the authorization server may challenge the user device for authentication. In some examples, such an authentication challenge may include a request that the user provide a password associated with the provided NAI. The authorization server may send an authentication message including the authentication challenge to the service provider network via the backchannel using HTTPS. In some examples, the authentication message may also include the certificate of the identity provider. The service provider network may relay the authentication message to the user device.

As previously mentioned, the service provider network may relay the authentication message to the user device over EAP. In some examples, the user agent on the user device, upon receiving the authentication challenge, may open up a captive portal window with the login prompts. The captive portal window may be configured to receive user input representing identity credentials associated with the cloud-based identity provider, such as, for example, a password. Additionally, or alternatively, the user agent, upon receiving the authentication challenge, may read the credentials from a secure datastore on the user device, such that the credentials have been previously entered and stored for later use. The user device may then generate a hash from the authentication credentials (e.g., the password) associated with the cloud-based identity provider. In some examples, the user device may encrypt data such as the hashed credentials, NAI, and/or the authentication challenge received from the cloud-based identity provider. The user device may encrypt the data using various methods, such as, for example, a key-based encryption. In some examples, the user device may retrieve the public key of the cloud-based identity provider from the received certificate and may encrypt the data with the public key. Additionally, or alternatively, such an encryption may be based on any other means of encryption, such as, for example, using the public key of the user device, a private key of the identity provider, and/or a private key of the user device. The user device may then send the encrypted authentication payload over EAP to the service provider network. The service provider network may then relay the encrypted authentication payload to the same authorization server over the backchannel using HTTPS.

Once received from the user device, the service provider network may relay the encrypted authentication payload to the authorization server without having access to the user credentials input on the user device. The authorization server associated with the cloud-based identity provider may then decrypt and validate the authentication challenge response material (e.g., the encrypted authentication payload) that it received from the service provider network. Such validation may include ensuring, by the cloud-based identity provider, that the user device's password, NAI, and/or the returned authentication challenge are associated with the specified user device. Once validated, the authorization server may perform various operations, such as but not limited to, granting the user device with access to the access network and/or challenging the user device for authorization.

As previously mentioned, the authorization server may challenge the user device for authorization. In some examples, the authorization server may send an authorization message, including the challenge and/or the scope URIs to the service provider network over the backchannel. Additionally, or alternatively, the authorization server may optionally sign the authorization message with a key, such as, for example, the private key of the authorization server, the public key of the authorization server, or the like.

In some examples, the service provider network may relay the authorization message to the user device over EAP. In some examples, the user agent on the user device, upon receiving the authorization challenge, may open up a captive portal window with the URIs for authorization. The captive portal window may be configured to receive user input representing authorization credentials associated with the cloud-based identity provider, such as, for example, a password. Additionally, or alternatively, the user agent, upon receiving the authorization challenge, may read the URIs from a policy file on the user device, such that the URIs may have been previously authorized and stored in the policy file for later use. The user device may then generate a hash from the authorization credentials (e.g., the password) associated with the cloud-based identity provider and/or utilize the previous hash from the authentication credentials. In some examples, the user device may encrypt data such as the hashed credentials, NAI, scope URIs, and/or the authorization challenge received from the cloud-based identity provider. The user device may encrypt the data using various methods, such as, for example, a key-based encryption. In some examples, the user device may retrieve the public key of the cloud-based identity provider from the received certificate and may encrypt the data with the public key. Additionally, or alternatively, such an encryption may be based on any other means of encryption, such as, for example, using the public key of the user device, a private key of the identity provider, and/or a private key of the user device. The user device may then send the encrypted authorization payload over EAP to the service provider network. The service provider network may then relay the encrypted authorization payload to the same authorization server over the backchannel using HTTPS.

Once received from the user device, the service provider network may relay the encrypted authorization payload to the authorization server without having access to the user credentials input on the user device. The authorization server associated with the cloud-based identity provider may then decrypt and validate the authorization challenge response material (e.g., the encrypted authorization payload) that it received from the service provider network. Such validation may include ensuring, by the cloud-based identity provider, that the user device's password, NAI, scope URIs, and/or the returned authorization challenge are associated with the specified user device.

Following authorization of the user device, the authorization server may generate access and/or identity tokens. In some example, the tokens are sent to the service provider network over the backchannel using HTTPS. Once the service provider network receives the tokens, the service provider network may send an EAP success message to the user device. In some examples, the EAP success message may not include the tokens generated by the authorization server. For example, the service provider network now has the identity token and/or access token from the authorization server and may perform various operations on behalf of the user. For example, the service provider network may use the identity token as an explicit authorization for certain default service(s) associated with the access network. Additionally, or alternatively, the service provider network may use the access token to access resources, associated with the access network and stored in association with a resource server, on behalf of the user.

Although the techniques described as being implemented utilizing a service provider network, including computing servers, data centers, and/or a cloud computing network, the techniques are generally applicable for any network of devices managed by an entity where virtual resources may be provisioned. In some instances, various components may be used in a system to perform the techniques described herein. The devices and components by which the techniques are performed herein are a matter of implementation, and the techniques described are not limited to any specific architecture or implementation.

The techniques described herein provide various improvements and efficiencies with respect user authorization and authentication for access to an access network using a cloud-based identity provider. For example, authorization and authentication payloads comprising user credentials may be encrypted with a public key of a cloud-based identity provider and transmitted from a user device over EAP to a service provider network, where the service provider network may relay the payload(s) to an authorization server associated with the cloud-based identity provider without exposing the user credentials to the service provider network. Such techniques may prevent user credential leakage (e.g., password exposure) to the service provider network by encrypting authorization and/or authentication payloads using a public key of the cloud-based identity provider. Additionally, separating the encrypted authorization and authentication payloads may prevent any replay attacks. Further, the service provider network may change the scope in the access token request that is sent to the user device over EAP, different from what the service provider sent to the authorization server. As such, the user device response securing the scope field in the response will allow the authorization server to detect such a replay attack.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

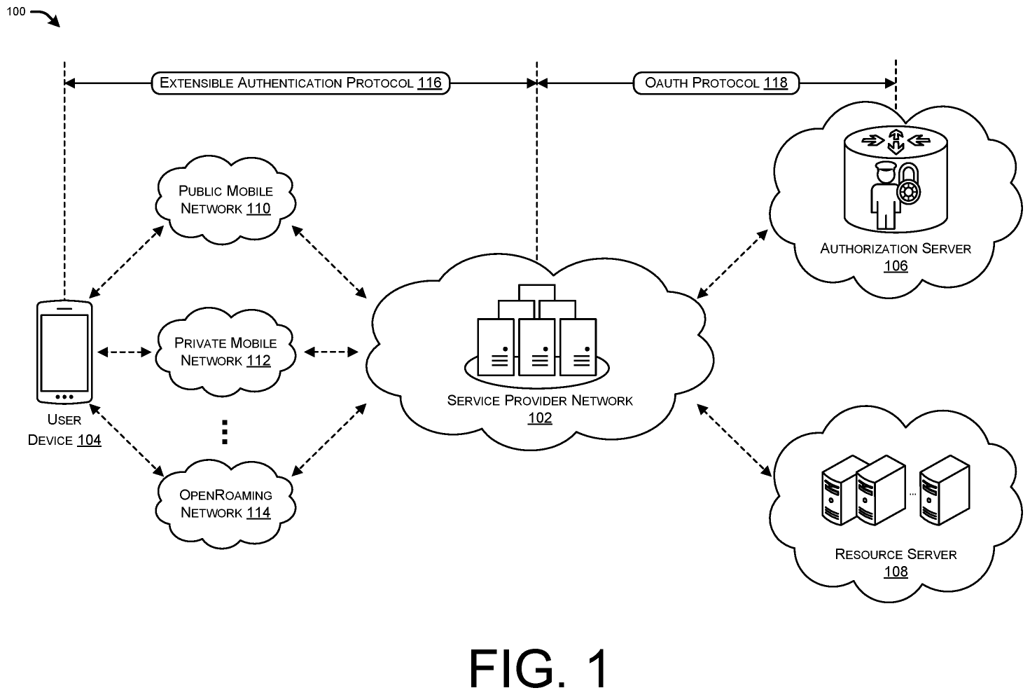

FIG. 1 illustrates a system-architecture diagram of an example environment 100 for implementing at least some of the various technologies disclosed herein. The environment includes an access network accessible by interacting with a service provider network 102 configured to securely transmit encrypted credentials from a user device 104 to a cloud-based authorization server 106 for authorization and authentication of the user device 104 to access the access network. Following authorization and authentication of the user device 104, the service provider network 102 may be configured to access resources from a resource server 108 associated with the access network on behalf of the user device 104. In some examples, the access network may be configured as a public mobile network 110 and/or a private mobile network 112 (e.g., a 5^{th} generation (5G) mobile network). Additionally, or alternatively, the access network may be configured as a public Wi-Fi network, a private Wi-Fi network, an OpenRoaming network 114, and/or any other access network may be contemplated.

In some examples, the user device 104 and the service provider network 102 may utilize an extensible authentication protocol (EAP) 116 for access authentication, while an OpenID Connect call flow may be activated on the backend, between the service provider network 102 and the authorization server 106 associated with a cloud-based identity provider, and tied with the EAP 116 access authentication, such that an authentication exchange that happens in classic OAuth protocol 118 between the user device 104 and the authorization server 106 may now be realized over EAP 116 by moving encrypted objects between the user device 104 and the cloud-based authorization server 106 without exposing the user's credentials to the service provider network 102. As further discussed herein, this approach may provide the ability for a user device 104 to use EAP 116 to complete access authentication with a cloud-based authorization server 106 that supports OAuth 118 and/or OpenID Connect.

In some examples, the user device 104 may comprise a personal user device (e.g., desktop computers, laptop computers, phones, tablets, wearable devices, entertainment devices such as televisions, etc.), network devices (e.g., servers, routers, switches, access points, etc.), and/or any other type of computing device. The user device 104 may comprise a user agent, or other software, installed thereon, such as, for example, an EAP supplicant. In some examples, the EAP supplicant may be configured to send and/or receive one or more messages and/or payloads from the service provider network 102 over EAP 116. Additionally, or alternatively, such messages and/or payloads may be further relayed to and/or from the user device 104 to and/or from the authorization server 106 by the service provider network via a backchannel between the service provider network 102 and the authorization server over HTTPS.

In some examples, the authorization server 106 may be associated with a cloud-based identity provider, such as, for example, “google.com,” “facebook.com,” “azure.net,” and/or any other cloud-based identity provider may be contemplated. The user device 104 may transmit encrypted authorization and/or authentication credentials associated with the cloud-based identity provider, such as, for example, a network access identifier (NAI) associated with the cloud-based identity provider (e.g., where the cloud-based identity provider is configured as “google.com,” then an example NAI may be “user@google.com), and/or an associated password. The authorization server 106 may then perform various operations to validate the encrypted objects received from the user device 104 via the service provider network 102 over the backchannel (OAuth 118) using HTTPS.

Additionally, as previously mentioned, the user device 104, service provider network 102, authorization server 106, and/or resource server 108 may communicate via one or more networks 110, 112, 114, such as the internet and/or a mobile network operator (MNO) network. The networks may include one or more networks 110, 112, 114 implemented by any viable communication technology, such as wired and/or wireless modalities and/or technologies. The networks 110, 112, 114 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof.

The service provider network 102 may facilitate providing access to a user device 104 to connect to an access network, such as, for example, a Wi-Fi network, a mobile network operator (MNO) network 110, 112, an OpenRoaming network 114, or any other type of access network. For example, the service provider network 102 may utilize EAP 116 to interwork with the authorization server 106 supporting OAuth protocol 118 based authentication and authorization interfaces to authenticate and authorize the user device 104 for access to the access network 110, 112, and/or 114.

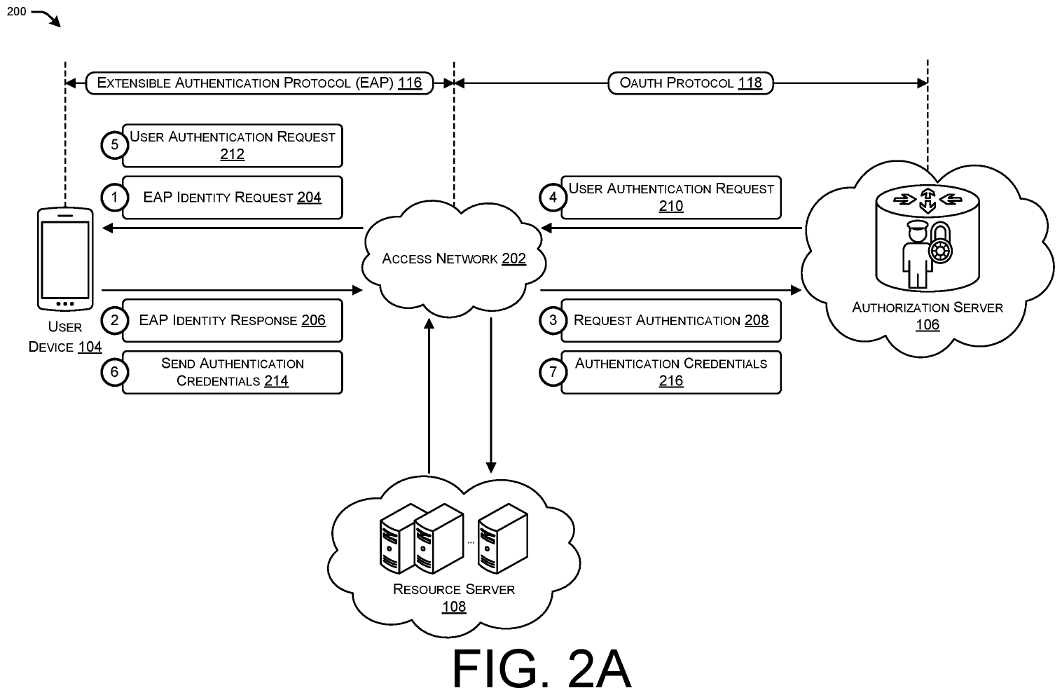

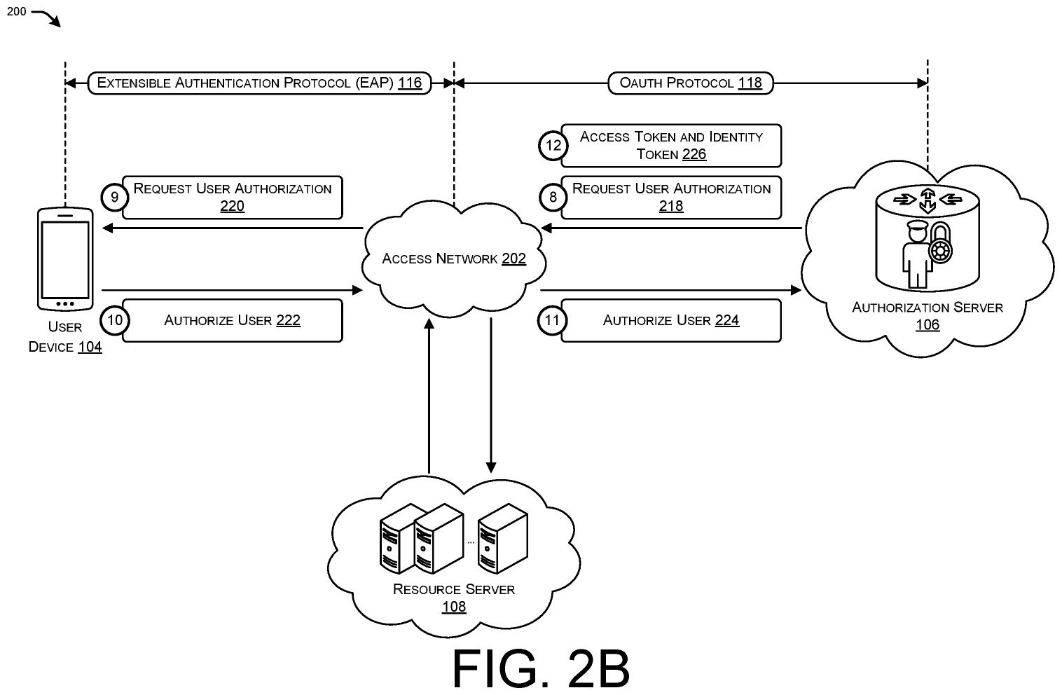

FIGS. 2A and 2B collectively illustrate a data flow diagram of an example process 200 according to which a user device 104 may attempt to access an access network 202 that utilizes a cloud-based authorization server 106 for authentication and authorization of the user device 104. Additionally, FIG. 2A illustrates a portion of the example process 200 where the authorization server 106 may authorize the user device 104, while FIG. 2B illustrates a portion of the example process 200 where the authorization server 106 may authenticate the user device 104.

In some examples, a user may wish to connect a user device 104 to an access network 202 (also referred to throughout the disclosure as a service provider network), such as, for example, a public and/or private Wi-Fi network, a public and/or private MNO network (e.g., a 5th generation (5G) mobile network), and/or an OpenRoaming network. In some examples, the user device 104 may have a user agent, or other software, installed thereon, such as, for example, an EAP supplicant. Additionally, or alternatively, the user agent may be configured to communicate with an access point associated with the access network 202 over EAP 116. Additionally, or alternatively, an OpenID Connect call flow may be activated on the backend, between the access network 202 and the authorization server 106 over a backchannel using HTTPS.

At “1,” The user device 104 may send a request for access to the network 202 to an access point associated with the network 202 and/or may otherwise attach to the network 202. In response, the access network 202 may return an EAP identity request 204 to the user device 104 over EAP 116. In some examples, the EAP identity request 204 may include an indication of a cloud-based identity provider realm. For example, with a cloud-based identity provider, such as, for example, “google.com,” the EAP identity request 204 may include an indication of a realm associated with the cloud-based identity provider, such as, for example, “@google.com”.

At “2,” in response to the EAP identity request 204, the user device may send an EAP identity response 206 to the access network 202 over EAP 116. In some examples, the EAP identity response 206 may include a network access identifier (NAI) associated with the cloud-based identity provider (e.g., user@gmail.com).

At “3,” once the access network 202 receives the EAP identity response 206, the access network 202 may make a backchannel authentication request 208 (via OAuth protocol 118), over HTTPS, for example, to an authorization server 106 associated with the cloud-based identity provider requesting an identity token. In some examples, the authentication request 208 may include an indication of the scope uniform resource identifiers (URIs) associated with the cloud-based identity provider and/or request for an additional access token. Additionally, or alternatively, the authentication request 208 may include an indication of the NAI associated with the cloud-based identity provider (e.g., user@gmail.com) received from the user device 104.

At “4,” in response to the backchannel authentication request 208, the authorization server 106 may challenge the user device 104 with a user authentication request 210, including an authentication challenge. In some examples, such an authentication challenge may include a request that the user provide a password associated with the provided NAI. The authorization server 106 may send the user authentication request 210 including the authentication challenge to the access network 202 via the backchannel using HTTPS (via OAuth protocol 118). In some examples, the user authentication request 210 may also include the certificate of the identity provider.

At “5,” the access network 202 may relay the user authentication request 212 to the user device 104 over EAP 116. In some examples, the user agent on the user device 104, upon receiving the authentication challenge, may open up a captive portal window with login prompts. The captive portal window may be configured to receive user input representing identity credentials associated with the cloud-based identity provider, such as, for example, a password. Additionally, or alternatively, the user agent, upon receiving the authentication challenge, may read the credentials from a secure datastore on the user device 104, such that the credentials have been previously entered and stored for later use. The user device 104 may then generate a hash from the authentication credentials (e.g., the password) associated with the cloud-based identity provider. In some examples, the user device 104 may encrypt data such as the hashed credentials, NAI, and/or the authentication challenge received from the authorization server 106. The user device 104 may encrypt the data using various methods, such as, for example, a key-based encryption. In some examples, the user device may retrieve the public key of the cloud-based identity provider from the received certificate and may encrypt the data with the public key. Additionally, or alternatively, such an encryption may be based on any other means of encryption, such as, for example, using the public key of the user device 104, a private key of the identity provider, and/or a private key of the user device 104.

At “6,” the user device 104 may then send the encrypted authentication payload, including the authentication credentials 214 over EAP 116 to the access network 202.

At “7,” once received from the user device 104, the access network 202 may relay the encrypted authentication payload, including the authentication credentials 216 to the authorization server 106 without having access to the user credentials input on the user device 104. The authorization server 106 associated with the cloud-based identity provider may then decrypt and validate the authentication challenge response material (e.g., the encrypted authentication payload) that it received from the access network 202. Such validation may include ensuring, by the cloud-based identity provider, that the user device's password, NAI, and/or the returned authentication challenge are associated with the specified user device 104. Once validated, the authorization server 106 may perform various operations, such as but not limited to, granting the user device 104 with access to the access network 202 and/or challenging the user device 104 for authorization.

With respect to FIG. 2B, further illustrated is a portion of the example process 200 where the authorization server 106 may authenticate the user device 104 for access to the access network 202. As previously mentioned, the authorization server 106 may challenge the user device 104 for authorization.

At “8,” the authorization server 106 may send a request for user authorization 218, including the challenge and/or the scope URIs to the access network over the backchannel using HTTPS (via OAuth protocol 118). Additionally, or alternatively, the authorization server 106 may optionally sign the request for user authorization 218 with a key, such as, for example, the private key of the authorization server 106, the public key of the authorization server 106, or the like.

At “9,” the access network 202 may relay the request for user authorization 220 to the user device 104 over EAP 116. In some examples, the user agent on the user device 104, upon receiving the request for user authorization 220, may open up a captive portal window with the URIs for authorization. The captive portal window may be configured to receive user input representing authorization credentials associated with the cloud-based identity provider, such as, for example, a password. Additionally, or alternatively, the user agent, upon receiving the request for user authorization 220, may read the URIs from a policy file on the user device 104, such that the URIs may have been previously authorized and stored in the policy file for later use. The user device 104 may then generate a hash from the authorization credentials (e.g., the password) associated with the cloud-based identity provider and/or utilize the previous hash from the authentication credentials. In some examples, the user device 104 may encrypt data such as the hashed credentials, NAI, scope URIs, and/or the authorization challenge received from the authorization server 106. The user device 104 may encrypt the data using various methods, such as, for example, a key-based encryption. In some examples, the user device 104 may retrieve the public key of the cloud-based identity provider from the received certificate and may encrypt the data with the public key. Additionally, or alternatively, such an encryption may be based on any other means of encryption, such as, for example, using the public key of the user device 104, a private key of the identity provider, and/or a private key of the user device 104.

At “10,” the user device 104 may then send the encrypted authorization payload to authorize the user 222 over EAP 116 to the access network.

At “11,” once received from the user device 104, the access network 202 may relay the encrypted authorization payload to authorize the user 224 to the authorization server 106 without having access to the user credentials input on the user device 104. The authorization server 106 associated with the cloud-based identity provider may then decrypt and validate the authorization challenge response material (e.g., the encrypted authorization payload) received from the access network 202 to authorize the user 224. Such validation may include ensuring, by the cloud-based identity provider, that the user device's password, NAI, scope URIs, and/or the returned authorization challenge are associated with the specified user device 104.

At “12,” following authorization of the user device 104, the authorization server 106 may generate access and/or identity tokens. In some example, the tokens are sent to the access network 202 over the backchannel using HTTPS (via OAuth protocol 118). Once the access network 202 receives the tokens, the access network 202 may send an EAP success message to the user device 104 over EAP. In some examples, the EAP success message may not include the tokens generated by the authorization server 106. For example, the access network 202 now has the identity token and/or access token from the authorization server 106 and may perform various operations on behalf of the user device 104. For example, the access network 202 may use the identity token as an explicit authorization for certain default service(s) associated with the access network 202. Additionally, or alternatively, the access network 202 may use the access token to access resources, associated with the access network 202 and stored in association with a resource server 108, on behalf of the user device 104.

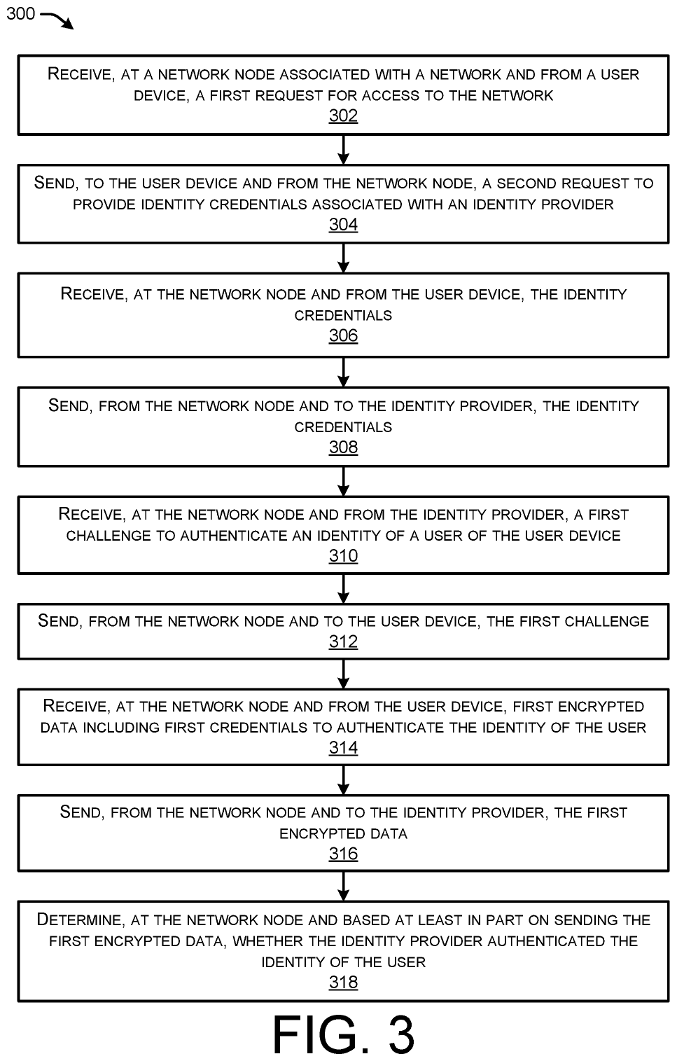

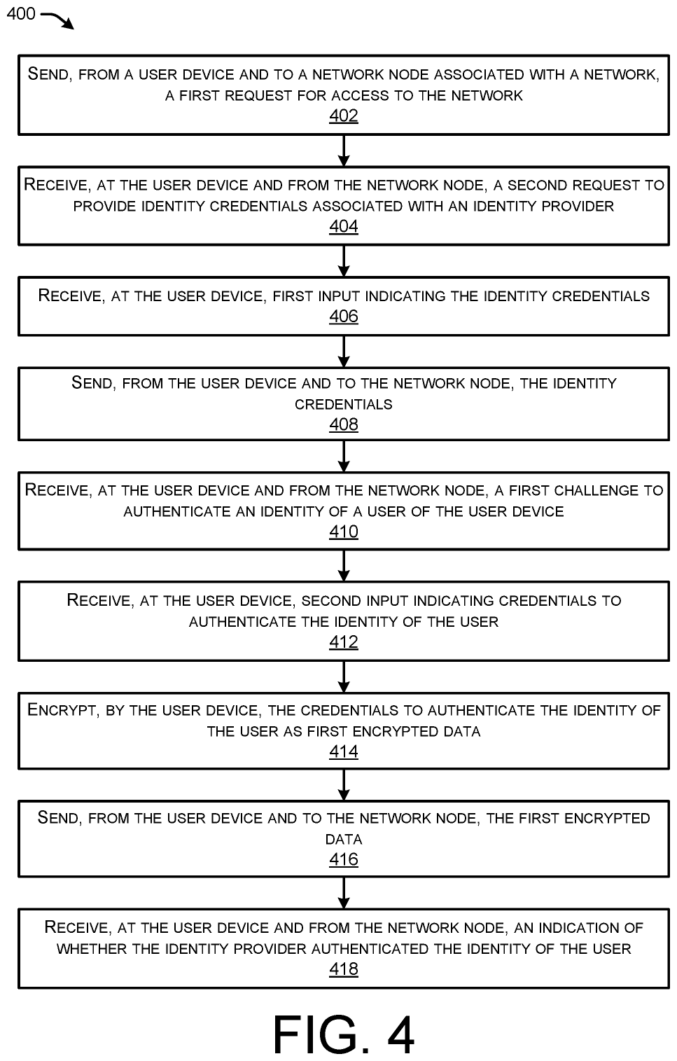

FIGS. 3 and 4 illustrate flow diagrams of example methods 300, and 400 that illustrate aspects of the functions performed at least partly by the service provider network 102, the user device 104, the authorizations server 106, and/or the access network 202 as described in FIGS. 1-2B. The logical operations described herein with respect to FIGS. 3 and 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 3 and 4, and as described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 3 illustrates a flow diagram of an example method 300 for using an enterprise traffic interception service 102 to enforce a policy that allows a client device 106 access to a service provider 104 using a direct connection.

At 302, the method 300 may include receiving, at an access point 102 and/or 202 associated with a network and from a user device 104, a first request for access to the network. Additionally, or alternatively, the user device 104 may otherwise attach to the network via the access point 102 and/or 202. In some examples, the access point 102 may be configured as any node in the network, such as, for example, a 5th generation (5G) session management function (SMF) and/or a similar node in a next-generation mobile network. Additionally, or alternatively, the access point may be configured as a wireless local area network controller.

At 304, the method 300 may include sending, to the user device 104 and from the access point 102 and/or 202, a second request to provide identity credentials associated with an identity provider. In some examples, the second request may be sent from the access point 102 and/or 202 and to the user device 104 over EAP 116. In some examples, the identity provider may be configured as a third-party cloud-based identity provider such as, for example, “google.com”. Additionally, or alternatively, the second request may include an indication of a realm associated with the cloud-based identity provider, such as, for example, “@google.com”.

At 306, the method 300 may include receiving, at the access point 102 and/or 202 and from the user device 104, the identity credentials. In some examples, the identity credentials may include a network access identifier (NAI) associated with the cloud-based identity provider (e.g., user@gmail.com). Additionally, or alternatively, the identity credentials may be sent from the user device 104 to the identity provider over EAP 116.

At 308, the method 300 may include sending, from the access point 102 and/or 202 and to the identity provider, the identity credentials. In some examples, the identity credentials may be sent over a backchannel between the access point 102 and/or 202 and the identity provider using HTTPS (via OAuth protocol 118).

At 310, the method 300 may include receiving, at the access point 102 and/or 202 and from the identity provider, a first challenge to authenticate an identity of a user of the user device 104. In some examples, the first challenge may be sent over a backchannel between the access point 102 and/or 202 and the identity provider using HTTPS (via OAuth protocol 118).

At 312, the method 300 may include sending, from the access point 102 and/or 202 and to the user device 104, the first challenge. In some examples, the first challenge may include a request that the user provide a password associated with the provided NAI. Additionally, or alternatively, the first challenge may be sent from the access point 102 and/or 202 and to the user device 104 over EAP 116.

At 314, the method 300 may include receiving, at the access point 102 and/or 202 and from the user device 104, first encrypted data including first credentials to authenticate the identity of the user. In some examples, the first encrypted data may not be accessible by the access point 102 and/or 202 such that the access point 102 and/or 202 may not be able to decrypt the first encrypted data. Additionally, or alternatively, the first encrypted data may be sent from the user device 104 and to the access point 102 and/or 202 over EAP 116.

At 316, the method 300 may include sending, from the access point 102 and/or 202 and to the identity provider, the first encrypted data. In some examples, the first encrypted data may be sent over a backchannel between the access point 102 and/or 202 and the identity provider using HTTPS (via OAuth protocol 118).

At 318, the method 300 may include determining, at the access point 102 and/or 202 and based at least in part on sending the first encrypted data, whether the identity provider authenticated the identity of the user. In some examples, the access point 102 and/or 202 may receive an indication from the identity provider that the identity of the user has been authenticated.

Additionally, or alternatively, the method 300 may include receiving, at the access point and from the identity provider, a second challenge to authorize the user device for a scope of access to the network, the scope of access indicating one or more services offered by the network. Additionally, or alternatively, the method 300 may include sending, from the access point and to the user device, the second challenge. Additionally, or alternatively, the method 300 may receiving, at the access point and from the user device, second encrypted data including second credentials to authorize the user device for the scope of access to the network. Additionally, or alternatively, the method 300 may include sending, from the access point and to the identity provider, the second encrypted data. Additionally, or alternatively, the method 300 may include determining, at the access point and based at least in part on sending the second encrypted data, whether the identity provider authorized the user device.

Additionally, or alternatively, the method 300 may include receiving, at the access point and from the identity provider, a first token granting access to the network and a second token indicating an authorization of the user device. Additionally, or alternatively, the method 300 may include accessing, by the access point and based at least in part on the first token, resources associated with the network on behalf of the user device. Additionally, or alternatively, the method 300 may include authorizing, by the access point and based at least in part on the second token, a default service associated with the network.

Additionally, or alternatively, the first credentials to authenticate the identity of the user comprise hashed credentials may be based at least in part on the identity credentials.

Additionally, or alternatively, at least one of the hashed credentials, a network address identifier associated with the identity provider, or the first challenge may be encrypted as the first encrypted data based at least in part on a key associated with the identity provider.

Additionally, or alternatively, the user device and the access point may be communicably coupled via an extensible authentication protocol (EAP) and the access point and the identity provider are communicably coupled using an OAuth protocol.

Additionally, or alternatively, the network may be at least one of: a public wireless network; a private wireless network; a public mobile network operator (MNO) network; or a private MNO network.

FIG. 4 illustrates a flow diagram of an example method 400 for using an enterprise traffic interception service 102 to enforce a policy that allows a client device 106 access to a service provider 104 using a proxied connection.

At 402, the method 400 may include sending, from a user device 104 and to an access point 102 and/or 202 associated with a network, a first request for access to the network. Additionally, or alternatively, the user device 104 may otherwise attach to the network via the access point 102 and/or 202. In some examples, the access point 102 may be configured as any node in the network, such as, for example, a 5th generation (5G) session management function (SMF) and/or a similar node in a next-generation mobile network. Additionally, or alternatively, the access point may be configured as a wireless local area network controller.

At 404, the method 400 may include receiving, at the user device 104 and from the access point 102 and/or 202, a second request to provide identity credentials associated with an identity provider. In some examples, the second request may be sent from the access point 102 and/or 202 and to the user device 104 over EAP 116. In some examples, the identity provider may be configured as a third-party cloud-based identity provider such as, for example, “google.com”. Additionally, or alternatively, the second request may include an indication of a realm associated with the cloud-based identity provider, such as, for example, “@google.com”.

At 406, the method 400 may include receiving, at the user device 104, first input indicating the identity credentials. In some examples, the identity credentials may include a network access identifier (NAI) associated with the cloud-based identity provider (e.g., user@gmail.com).

At 408, the method 400 may include sending, from the user device 104 and to the access point 102 and/or 202, the identity credentials. In some examples, the identity credentials may be sent from the user device 104 to the identity provider over EAP 116.

At 410, the method 400 may include receiving, at the user device 104 and from the access point 102 and/or 202, a first challenge to authenticate an identity of a user of the user device 104. In some examples, the first challenge may include a request that the user provide a password associated with the provided NAI. Additionally, or alternatively, the first challenge may be sent from the access point 102 and/or 202 and to the user device 104 over EAP 116.

At 412, the method 400 may include receiving, at the user device 104, second input indicating first credentials to authenticate the identity of the user. In some examples, the first credentials may include a password associated with the provided NAI.

At 414, the method 400 may include encrypting, by the user device 104, the first credentials to authenticate the identity of the user as first encrypted data. The user device 104 may encrypt the data using various methods, such as, for example, a key-based encryption. In some examples, the user device 104 may retrieve the public key of the identity provider from a received certificate included in prior communications and may encrypt the data with the public key. Additionally, or alternatively, such an encryption may be based on any other means of encryption, such as, for example, using the public key of the user device 104, a private key of the identity provider, and/or a private key of the user device 104.

At 416, the method 400 may include sending, from the user device 104 and to the access point 102 and/or 202, the first encrypted data. In some examples, the first encrypted data may not be accessible by the access point 102 and/or 202 such that the access point 102 and/or 202 may not be able to decrypt the first encrypted data. Additionally, or alternatively, the first encrypted data may be sent from the user device 104 and to the access point 102 and/or 202 over EAP 116.

At 418, the method 400 may include receiving, at the user device 104 and from the access point 102 and/or 202, an indication of whether the identity provider authenticated the identity of the user. In some examples, the access point 102 and/or 202 may receive an indication from the identity provider that the identity of the user has been authenticated, and the access point 102 and/or 202 may relay such an indication to the user device 104 over EAP.

Additionally, or alternatively, the method 400 may include generating, by the user device 104 and based at least in part on the first credentials and the identity credentials, hashed credentials.

Additionally, or alternatively, the method 400 may include encrypting, by the user device 104 and based at least in part on a key associated with at least one of the identity provider or the user device 104, at least one of the hashed credentials, a network access identifier associated with the identity provider, and/or the first challenge as the first encrypted data.

Additionally, or alternatively, the method 400 may include receiving, at the user device 104 and from the access point, a second challenge to authorize the user device 104 for a scope of access to the network, the scope of access indicating one or more services offered by the network. Additionally, or alternatively, the method 400 may include receiving, at the user device 104, third input indicating second credentials to authorize the user device 104 for the scope of access to the network. Additionally, or alternatively, the method 400 may include generating, by the user device 104 and based at least in part on the second credentials and the identity credentials, hashed credentials. Additionally, or alternatively, the method 400 may include encrypting, by the user device 104 and based at least in part on a key associated with at least one of the identity provider or the user device 104, at least one of the hashed credentials, a network access identifier associated with the identity provider, or the second challenge as second encrypted data. Additionally, or alternatively, the method 400 may include sending, from the user device 104 and to the access point 102 and/or 202, the second encrypted data.

Additionally, or alternatively, the user device and the access point may be communicably coupled via an extensible authentication protocol (EAP).

Additionally, or alternatively, the network may be at least one of: a public wireless network; a private wireless network; a public mobile network operator (MNO) network; or a private MNO network.

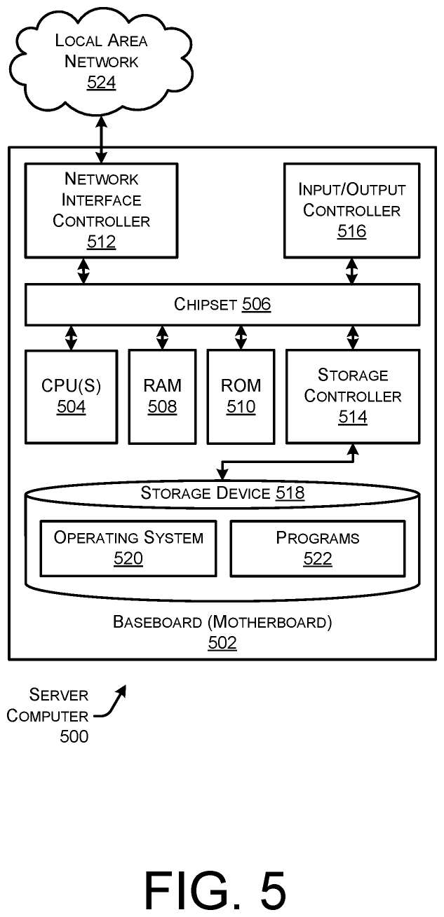

FIG. 5 illustrates a computer architecture diagram showing an example computer hardware architecture for implementing a network device that can be utilized to implement aspects of the various technologies presented herein. The computer architecture shown in FIG. 5 illustrates a conventional server computer, workstation, desktop computer, laptop, tablet, network appliance, e-reader, smartphone, or other computing device, and can be utilized to execute any of the software components presented herein. The computer 500 may, in some examples, comprise networked devices such as servers, switches, routers, hubs, bridges, gateways, modems, repeaters, access points, etc.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network 524, such as the networks 110, 112, 114, and/or 202. The chipset 506 can include functionality for providing network connectivity through a NIC 512, such as a gigabit Ethernet adapter. The NIC 512 is capable of connecting the computer 500 to other computing devices over the networks 116. It should be appreciated that multiple NICs 512 can be present in the computer 500, connecting the computer to other types of networks and remote computer systems.

The computer 500 can be connected to a storage device 518 that provides non-volatile storage for the computer. The storage device 518 can store an operating system 520, programs 522, and data, which have been described in greater detail herein. The storage device 518 can be connected to the computer 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the various components in the environment 100 may be supported by one or more devices similar to computer 500. Stated otherwise, some or all of the operations performed by the various components in the environment 100 may be performed by one or more computer devices 500 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes described above with regard to FIGS. 1-4. The computer 500 can also include computer-readable storage media having instructions stored thereupon for performing any of the other computer-implemented operations described herein.

The computer 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computer 500 might not include all of the components shown in FIG. 5, can include other components that are not explicitly shown in FIG. 5, or might utilize an architecture completely different than that shown in FIG. 5.

As described herein, the computer 500 may comprise one or more functionalities associated with a service provider network 102, a user device 104, an authorization server 106, and/or an access network 202. The computer 500 may include one or more hardware processors 504 (processors) configured to execute one or more stored instructions. The processor(s) 504 may comprise one or more cores. Further, the computer 500 may include one or more network interfaces configured to provide communications between the computer 500 and other devices, such as the communications described herein as being performed by the service provider network 102, the user device 104, the authorizations server 106, and/or the access network 202. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 522 may comprise any type of programs or processes to perform the techniques described in this disclosure. The programs 522 may enable the client device 106 to perform various operations.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a network node associated with a network and from a user device, a first request for access to the network;
sending, to the user device and from the network node, a second request to provide identity credentials associated with an identity provider;
receiving, at the network node and from the user device, the identity credentials;
sending, from the network node and to the identity provider, the identity credentials;
receiving, at the network node and from the identity provider, a first challenge to authenticate an identity of a user of the user device;
sending, from the network node and to the user device, the first challenge;
receiving, at the network node and from the user device, first encrypted data including first credentials to authenticate the identity of the user;
sending, from the network node and to the identity provider, the first encrypted data; and
determining, at the network node and based at least in part on sending the first encrypted data, whether the identity provider authenticated the identity of the user.

2. The method of claim 1, further comprising:
receiving, at the network node and from the identity provider, a second challenge to authorize the user device for a scope of access to the network, the scope of access indicating one or more services offered by the network;
sending, from the network node and to the user device, the second challenge;
receiving, at the network node and from the user device, second encrypted data including second credentials to authorize the user device for the scope of access to the network;
sending, from the network node and to the identity provider, the second encrypted data; and
determining, at the network node and based at least in part on sending the second encrypted data, whether the identity provider authorized the user device.

3. The method of claim 1, further comprising:
receiving, at the network node and from the identity provider, a first token granting access to the network and a second token indicating an authorization of the user device;
accessing, by the network node and based at least in part on the first token, resources associated with the network on behalf of the user device; and
authorizing, by the network node and based at least in part on the second token, a default service associated with the network.

4. The method of claim 1, wherein the first credentials to authenticate the identity of the user comprise hashed credentials based at least in part on the identity credentials.

5. The method of claim 4, wherein at least one of the hashed credentials, a network address identifier associated with the identity provider, or the first challenge is encrypted as the first encrypted data based at least in part on a key associated with the identity provider.

6. The method of claim 1, wherein the user device and the network node are communicably coupled via an extensible authentication protocol (EAP) and the network node and the identity provider are communicably coupled using an OAuth protocol.

7. The method of claim 1, wherein the network is at least one of:
a public wireless network;
a private wireless network;
a public cellular network;
a private cellular network; or
an integrated private network.

8. A method comprising:
sending, from a user device and to a network node associated with a network, a first request for access to the network;
receiving, at the user device and from the network node, a second request to provide identity credentials associated with an identity provider;
receiving, at the user device, first input indicating the identity credentials;
sending, from the user device and to the network node, the identity credentials;
receiving, at the user device and from the network node, a first challenge to authenticate an identity of a user of the user device;
receiving, at the user device, second input indicating first credentials to authenticate the identity of the user;
encrypting, by the user device, the first credentials to authenticate the identity of the user as first encrypted data;
sending, from the user device and to the network node, the first encrypted data; and
receiving, at the user device and from the network node, an indication of whether the identity provider authenticated the identity of the user.

9. The method of claim 8, further comprising generating, by the user device and based at least in part on the first credentials and the identity credentials, hashed credentials.

10. The method of claim 9, further comprising encrypting, by the user device and based at least in part on a key associated with at least one of the identity provider or the user device, at least one of the hashed credentials, a network access identifier associated with the identity provider, or the first challenge as the first encrypted data.

11. The method of claim 8, further comprising:
receiving, at the user device and from the network node, a second challenge to authorize the user device for a scope of access to the network, the scope of access indicating one or more services offered by the network;
receiving, at the user device, third input indicating second credentials to authorize the user device for the scope of access to the network;
generating, by the user device and based at least in part on the second credentials and the identity credentials, hashed credentials;
encrypting, by the user device and based at least in part on a key associated with at least one of the identity provider or the user device, at least one of the hashed credentials, a network access identifier associated with the identity provider, or the second challenge as second encrypted data; and
sending, from the user device and to the network node, the second encrypted data.

12. The method of claim 8, wherein the user device and the network node are communicably coupled via an extensible authentication protocol (EAP).

13. The method of claim 8, wherein the network is at least one of:
a public wireless network;
a private wireless network;
a public cellular network;
a private cellular network; or
an integrated private network.

14. A system comprising:
one or more processors; and
one or more non-transitory computer-readable media storing computer-executable instructions that, when executed by the one or more processors, cause the one or more processors to perform operations comprising:
receiving, at a network node associated with a network and from a user device, a first request for access to the network;
sending, to the user device and from the network node, a second request to provide identity credentials associated with an identity provider;
receiving, at the network node and from the user device, the identity credentials;
sending, from the network node and to the identity provider, the identity credentials;
receiving, at the network node and from the identity provider, a first challenge to authenticate an identity of a user of the user device;
sending, from the network node and to the user device, the first challenge;
receiving, at the network node and from the user device, first encrypted data including credentials to authenticate the identity of the user;
sending, from the network node and to the identity provider, the first encrypted data; and
determining, at the network node and based at least in part on sending the first encrypted data, whether the identity provider authenticated the identity of the user.

15. The system of claim 14, the operations further comprising:
receiving, at the network node and from the identity provider, a second challenge to authorize the user device for a scope of access to the network, the scope of access indicating one or more services offered by the network;
sending, from the network node and to the user device, the second challenge;
receiving, at the network node and from the user device, second encrypted data including the credentials to authorize the user device for the scope of access to the network;
sending, from the network node and to the identity provider, the second encrypted data; and
determining, at the network node and based at least in part on sending the second encrypted data, whether the identity provider authorized the user device.

16. The system of claim 14, the operations further comprising:
receiving, at the network node and from the identity provider, a first token granting access to the network and a second token indicating an authorization of the user device;
accessing, by the network node and based at least in part on the first token, resources associated with the network on behalf of the user device; and
authorizing, by the network node and based at least in part on the second token, a default service associated with the network.

17. The system of claim 14, wherein the credentials to authenticate the identity of the user comprise hashed credentials based at least in part on the identity credentials.

18. The system of claim 17, wherein at least one of the hashed credentials, a network address identifier associated with the identity provider, or the first challenge is encrypted as the first encrypted data based at least in part on a key associated with the identity provider.

19. The system of claim 14, wherein the user device and the network node are communicably coupled using an extensible authentication protocol (EAP) and the network node and the identity provider are communicably coupled using an OAuth protocol.

20. The system of claim 14, wherein the network is at least one of:
a public wireless network;
a private wireless network;
a public cellular network;
a private cellular network; or
an integrated private network.
